(19) United States
(12) Patent Application Publication
(10) Pub. No.: US 2026/0046665 A1
(43) Pub. Date: Feb. 12, 2026

(54) BEAM PAIR DETERMINATION FOR THE FORWARD LINK OF NETWORK-CONTROLLED REPEATER

(71) Applicant: Lenovo (Singapore) Pte. Limited, Singapore (SG)

(72) Inventors: Ali Ramadan Ali, Kraiburg am Inn (DE); Seyedomid Taghizadeh Motlagh, Oberursel (DE); Ahmed Hindy, Aurora, IL (US)

(21) Appl. No.: 19/102,769

(22) PCT Filed: Aug. 7, 2023
(86) PCT No.: PCT/IB2023/057961

§ 371 Date: Feb. 10, 2025

Related U.S. Application Data
(60) Provisional application No. 63/371,073, filed on Aug. 10, 2022.

(51) Int. Cl. H04W 24/10; H04B 7/06

(52) U.S. Cl. CPC H04W 24/10; H04B 7/06962

(57) ABSTRACT

A repeater device receives a first configuration that associates reference signal (RS) resources and receive/transmit (Rx/Tx) beam pairs configurable at the repeater device for repeating one of: (i) a downlink (DL) radio frequency (RF) signal received on a backhaul link from the base station to a user equipment (UE) over an access link; and (ii) an uplink (UL) RF signal from the UE to the base station. The device: receives a second configuration for measuring and reporting self-interference of a first list of the RS resources; configures the repeater device with Rx/Tx beam pairs identified in the first list of RS resources; measures self-interference received on an Rx beam of first Rx/Tx beam pairs; and generates and forwards, to the base station, a self-interference measurement report comprising a second list of Rx/Tx beam pairs from the first list of Rx/Tx beam pairs that cause self-interference above a threshold value.

### PRIORITY APPLICATION

This application claims priority to U.S. Provisional Application 63/371,073 filed Aug. 10, 2022, the content of which fully incorporated herein.

### TECHNICAL FIELD

The present disclosure relates to wireless communications, and more specifically to repeating wireless communication using receive-transmit beam pair selection.

### BACKGROUND

A wireless communications system may include one or multiple network communication devices, including base stations or network device, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, and other suitable radio access technologies beyond 5G (e.g., sixth generation (6G)).

Coverage is a fundamental aspect of cellular network deployments. Mobile operators rely on different types of network nodes to offer blanket coverage in their deployments. Deployment of regular full-stack cells is one option but may not be always technically possible or economically viable. As a result, new types of network nodes have been considered to increase mobile operators'flexibility for their network deployments. For example, Integrated Access and Backhaul (IAB) is a new type of network node not requiring a wired backhaul. Another type of network node is a radio frequency (RF) repeater that simply amplifies-and-forwards any signal that the RF repeater receives. RF repeaters have seen a wide range of deployments in 2G, 3G and 4G to supplement the coverage provided by regular full-stack cells. The 5G New Radio (NR) radio access technologies (RATs) have RF and Electromagnetic Compatibility (EMC) requirements for such RF repeaters for NR targeting both Frequency Range 1 (FR1) and Frequency Range 2 (FR2).

### SUMMARY

The present disclosure relates to methods, apparatuses, and systems for repeating wireless communication to extend coverage areas for network devices. In particular, a network device communicates with a network-controlled repeater (NCR) via a side control link to configure the NCR to forward communications and to configure the NCR to measure self-interference. Effectiveness of the repeating wireless communication is based in part on measuring reference signals forwarded through each beam pair at the NCR that are measured at a terminating device (i.e., user equipment (UE) or network device). Effectiveness of the repeating wireless communication is also based on measuring self-interference at the NCR.

Some implementations of the method and apparatuses described herein may further include receiving, via at least one transceiver of a repeater device on a control link from at least one network device, a first configuration that associates reference signal (RS) resources and more than one receive/transmit (Rx/Tx) beam pairs. The Rx/Tx beam pairs are configurable at the repeater device for repeating one of: (i) a downlink (DL) radio frequency (RF) signal received on a backhaul link from the at least one network device to a user device over an access link; and (ii) an uplink (UL) RF signal from the user device to the at least one network device. The method and apparatuses described herein may further include receiving, via the control link from the at least one network device, a second configuration for measuring and reporting self-interference of a first list of the RS resources. The method and apparatuses described herein may further include configuring the transceiver with Rx/Tx beam pairs identified in the first list of RS references. The method and apparatuses described herein may further include, while transmitting, via the transceiver over one of the access link and the backhaul link, a first RF signal via a Tx beam of a first Rx/Tx beam pair identified in the first list, measuring self-interference received by the at least one transceiver on an Rx beam of the first Rx/Tx beam pairs. The method and apparatuses described herein may further include generating and forwarding, to the at least one network device, a self-interference measurement report comprising a second list of Rx/Tx beam pairs, the second list being a first subset of Rx/Tx beam pairs from the first list of Rx/Tx beam pairs that causes self-interference above a threshold value.

Some implementations of the method and apparatuses described herein for repeating wireless communication may further include transmitting, via at least one transceiver on a control link to a repeater device, a first configuration that associates RS resources and more than one Rx/Tx beam pairs. The Rx/Tx beam pairs are configurable at the repeater device for repeating one of: (i) a DL RF signal from the at least one network device over a backhaul link to the repeater device for repeating over an access link to a user device; and (ii) an UL RF signal from the user device to the at least one network device. Some implementations of the method and apparatuses described herein may further include transmitting, via the control link to the user device, a second configuration comprising a first list of RS resources that configure the repeater device with pairs of Rx/Tx beam pairs to one of: (i) measure and report self-interference at the repeater device for a Tx beam on the access link interfering with an Rx beam on the backhaul link; (ii) measure and report self-interference at the repeater device for a Tx beam on the backhaul link interfering with an Rx beam on the access link; (iii) repeat a reference signal from the at least one network device for measuring and reporting by the user device; and (iv) repeat a reference signal from the user device for measuring by the at least one network device.

### BRIEF DESCRIPTION OF THE DRAWINGS

FIG. 1 illustrates an example of a wireless communications system enabling repeating of wireless communication by a network-controller repeater (NCR) device, in accordance with aspects of the present disclosure.

FIG. 2 illustrates a portion of the wireless communications system including a network device, the NCR device, and user equipment (UE) that is outside of a coverage area for the network device, in accordance with aspects of the present disclosure;

FIG. 3 illustrates a diagram of the wireless communication system for repeating wireless communication by an NCR forwarding section, illustrating NCR Receive/Transmit (Rx/Tx) beam pairs and self-interference., in accordance with aspects of the present disclosure.

FIG. 4 illustrates is a block diagram of the wireless communication system with the NCR device configured by the network device to receive and forward multiple CSI-RS beams on the forward link to a UE for DL beam selection and refinement, in accordance with aspects of the present disclosure.

FIG. 5 illustrates a diagram of the wireless communication system with the NCR device configured by the network device to receive and forward multiple SRS resources/beams from the UE to the network device, in accordance with aspects of the present disclosure.

FIG. 6 illustrates a block diagram of a device that performs manages or performs repeating of wireless communication, in accordance with aspects of the present disclosure.

FIG. 7 illustrates a flowchart of a method performed by a repeater device for repeating wireless communication to extend coverage areas for network devices, in accordance with aspects of the present disclosure.

FIG. 8 illustrates a flowchart of a method performed by a network device for managing the repeating of wireless communication to extend coverage area by a repeater devices, in accordance with aspects of the present disclosure.

### DETAILED DESCRIPTION

While a conventional RF repeater presents a cost-effective means of extending network coverage to a communications system, the RF repeater has its limitations. An RF repeater simply does an amplify-and-forward operation, lacking the communication performance enhancements performed by either a network device or a user equipment (UE) using spatial information to receive or transmit by selecting appropriate beams. As an improvement over conventional RF repeaters, a network-controlled repeater (NCR) can be configured by a network device via a side control link, enabling performance improvements. One of the conventional solutions to select the best Rx/Tx beam pair for forwarding physical channels at the NCR is that the network device sends multiple Channel State Information Reference Signal (CSI-RS) resources and configures the NCR to switch its Receive (Rx) backhaul beams and Transmit (Tx) access beams for each CSI-RS resource to create different combination of beam pairs. The UE can report the Channel State Information (CSI) for each combination such that the network device determines the best combination for the forward link. In some cases, the cause of low-quality reported CSI corresponding to a certain Rx/Tx beam pair is due to the self-interference between the Tx and Rx antennas array of the NCR and not due to the channel quality.

For some of deployment scenarios of the NCR, the backhaul and access antennas are close to each other, and hence isolating the antenna is difficult. The NCR may support dynamic beamforming for which the transmitted signal of one link in one beam or a side lobe of a Tx beam may be received by the antenna array of the other link leading to a self-interference at the NCR that may be difficult to cancel using conventional RF cancellation methods. For such a case, the reported CSI of this combination of beam pair (Rx beam of the backhaul and the Tx beam of the access link) would be expected to remain at a low quality for the rest of the communication with the UE regardless of the channel change. The self-interference in the NCR occurs since the NCR receives and transmits in the same bandwidth at the same time. A slightly delayed version of the transmitted signal is added to the receive antenna leading to an oscillation interference effect.

According to aspects of the present disclosure, apparatuses and methods enable the network device and/or the NCR to determine the best Rx/Tx beam pairs for forwarding the physical channels and the Rx/Tx beam pairs to be discarded from configuration due to the self-interference. The network device identifies the failed Rx/Tx beam pairs based on the UE report of CSI-RS, the network device measurement of a Sounding Reference Signal (SRS) and/or the NCR report on self-interference. The network device triggers the NCR to measure the self-interference during measurement of the CSI-RS by the UE and during measurement of the SRS by the network device. The network device and/or the NCR use the measurements for identified Rx/Tx beam pairs to discard Rx/Tx beam pairs from the beam associating configuration of the NCR if these beam pairs are reported from the NCR as the cause of the self-interference.

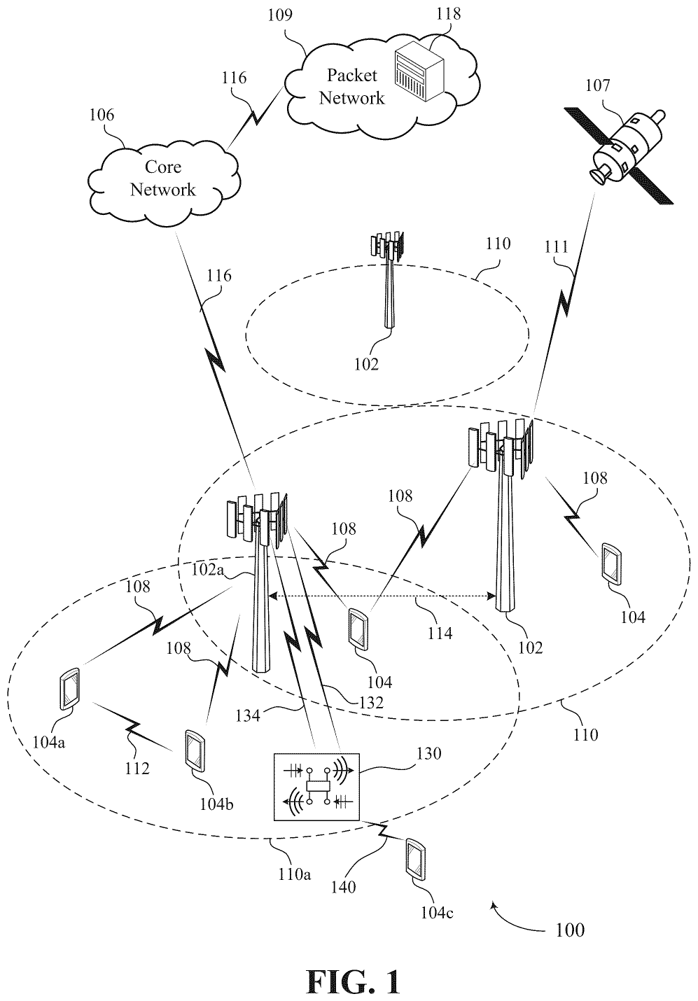

FIG. 1 illustrates an example of a wireless communications system 100 enabling repeating of wireless communication by a network-controller repeater (NCR) device, in accordance with aspects of the present disclosure. The wireless communications system 100 may include one or more network devices 102, one or more UEs 104, a core network 106, and a packet data network 109. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a New Radio (NR) network. In other implementations, the wireless communications system 100 may be a combination of a 4G network and a 5G network. The wireless communications system 100 may support radio access technologies beyond 5G, or other suitable radio access technology including Institute of Electrical and Electronics Engineers (IEEE) 802.11 (Wi-Fi), IEEE 802.16 (WiMAX), IEEE 802.20. Additionally, the wireless communications system 100 may support technologies, such as time division multiple access (TDMA), frequency division multiple access (FDMA), or code division multiple access (CDMA), etc.

The one or more network devices 102 may be dispersed throughout a geographic region to form the wireless communications system 100. One or more of the network devices 102 described herein may be, may include, or may be referred to as a network node, a base station, a network element, a radio access network (RAN), a base transceiver station, an access point, a NodeB, an eNodeB (eNB), a next-generation NodeB (gNB), a network device, or other suitable terminology. A network device 102 and a UE 104 may communicate via a communication link 108, which may be a wireless or wired connection. For example, a network device 102 and a UE 104 may wirelessly communicate (e.g., receive signaling, transmit signaling) over a user to user (Uu) interface.

A network device 102 may provide a geographic coverage area 110 for which the network device 102 may support services (e.g., voice, video, packet data, messaging, broadcast, etc.) for one or more UEs 104 within the geographic coverage area 110. For example, a network device 102 and a UE 104 may support wireless communication of signals related to services (e.g., voice, video, packet data, messaging, broadcast, etc.) according to one or multiple radio access technologies. In some implementations, a network device 102 may be moveable, for example, a satellite 107 associated with a non-terrestrial network and communicating via a satellite link 111. In some implementations, different geographic coverage areas 110 associated with the same or different radio access technologies may overlap, but the different geographic coverage areas 110 may be associated with different network devices 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network devices 102, other UEs 104, or network equipment (e.g., the core network 106, the packet data network 109, a relay device, an integrated access and backhaul (IAB) node, or another network equipment), as shown in FIG. 1. Additionally, or alternatively, a UE 104 may support communication with other network devices 102 or UEs 104, which may act as relays in the wireless communications system 100.

A UE 104a may also be able to support wireless communication directly with other UEs 104b over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104a may support wireless communication directly with another UE 104b over a PC5 interface. PC5 refers to a reference point where the UE 104a directly communicates with another UE 104b over a direct channel without requiring communication with the network device 102a.

A network device 102 may support communications with the core network 106, or with another network device 102, or both. For example, a network device 102 may interface with the core network 106 through one or more backhaul links 114 (e.g., via an S1, N2, or another network interface). The network devices 102 may communicate with each other over the backhaul links 114 (e.g., via an X2, Xn, or another network interface). In some implementations, the network devices 102 may communicate with each other directly (e.g., between the network devices 102). In some other implementations, the network devices 102 may communicate with each other indirectly (e.g., via the core network 106). In some implementations, one or more network devices 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission and reception points (TRPs).

In some implementations, a network entity or network device 102 may be configured in a disaggregated architecture, which may be configured to utilize a protocol stack physically or logically distributed among two or more network entities or network devices 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity or network device 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission and reception point (TRP). One or more components of the network entities or network devices 102 in a disaggregated RAN architecture may be co-located, or one or more components of the network entities or network devices 102 may be located in distributed locations (e.g., separate physical locations). In some implementations, one or more network entities or network devices 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities or network devices 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more network devices 102 associated with the core network 106.

The core network 106 may communicate with the packet data network 109 over one or more backhaul links 116 (e.g., via an S1, N2, N2, or another network interface). The packet data network 109 may include an application server 118. In some implementations, one or more UEs 104 may communicate with the application server 118. A UE 104 may establish a session (e.g., a protocol data unit (PDU) session, or the like) with the core network 106 via a network entity or network device 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities or network devices 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the network entities or network devices 102 and the UEs 104 may support different resource structures. For example, the network entities or network devices 102 and the UEs 104 may support different frame structures. In some implementations, such as in 4G, the network entities or network devices 102 and the UEs 104 may support a single frame structure. In some other implementations, such as in 5G and among other suitable radio access technologies, the network entities or network devices or network devices 102 and the UEs 104 may support various frame structures (i.e., multiple frame structures). The network entities or network devices 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities or network devices 102 and the UEs 104 may perform wireless communications over one or more of the operating frequency bands. In some implementations, FR1 may be used by the network entities or network devices 102 and the UEs 104, among other equipment or devices for cellular communications traffic (e.g., control information, data). In some implementations, FR2 may be used by the network entities or network devices 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

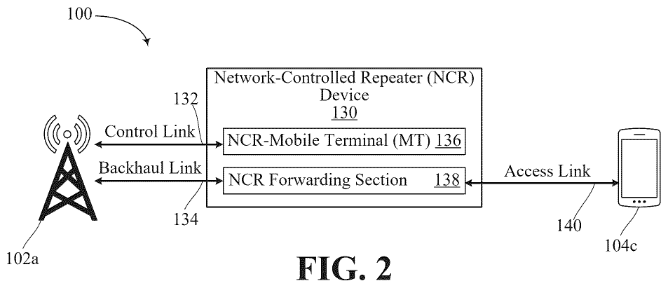

FIG. 2 illustrates a portion of the wireless communications system 100 including the network device 102a, an NCR device 130 and a UE 104c that is outside of a coverage area 110a (FIG. 1) for the network device 102a. With reference to FIGS. 1-2, wireless communications system 100 may extend a coverage area 110a for the network device 102a by including an NCR device 130 that is able to reach a UE 104c. NCR device 130 communicates with the network device 102a via both a side control link 132, which may be referred to as a “C-link”, and via a backhaul link 134. With particular reference to FIG. 2, the side control link 132 terminates at the NCR device 130 that accordingly acts as an NCR mobile terminal (NCR-MT) 136. The NCR device 130 includes an NCR forwarding section 138 that receives and amplifies a DL radio frequency (RF) signal received via the backhaul link 134 and forwards the DL RF signal with minimal delay via an access link 140 to the UE 104c. Similarly, the NCR forwarding section 138 receives and amplifies an UL RF signal received via the access link 140 and forwards the UL RF signal with minimal delay via the backhaul link to the network device 102a. The network device 102a is able to configure the NCR forwarding section 138 via configuration information sent via the side control link 132 to the NCR-MT 136.

Aspects of the present disclosure may apply more generally to communication links referred to with different labels. In one or more embodiments, the control link 132 may generally be a first link, the backhaul link 134 may generally be a second link, and the access link 140 may generally be a third link.

In one or more embodiments, the NCR device 130 is configured by the network device 102a to receive and forward multiple CSI-RS beams on the forward link to a UE 104a for DL beam selection/refinement. The configuration DL beam selection/refinement includes indication for associating each of the CSI-RS resources with a beam pair of an Rx beam and a Tx beam at the NCR device 130. Upon receiving the CSI report from the UE 104a for each beam configured for the repeater Rx/Tx beam pair (CSI-RS configured for the UE), the network device 102a sends a second configuration to the NCR device 130 with a list of CSI-RS resources corresponding to a set of beam pairs reported by the UE 104a with low-quality CSI measurement. The NCR device 130 is configured to measure the self-interference power in the RF circuit of the forwarding section 138 for each of the indicated list of the CSI-RS resources and report the ones that cause self-interference at the NCR device 130. The network device 102a sends to the NCR device 130 a third configuration. The third configuration includes a new association of CSI-RS resources with the beam pairs at the NCR device 130 such that the beam pairs with high self-interference are not considered by the NCR device 130.

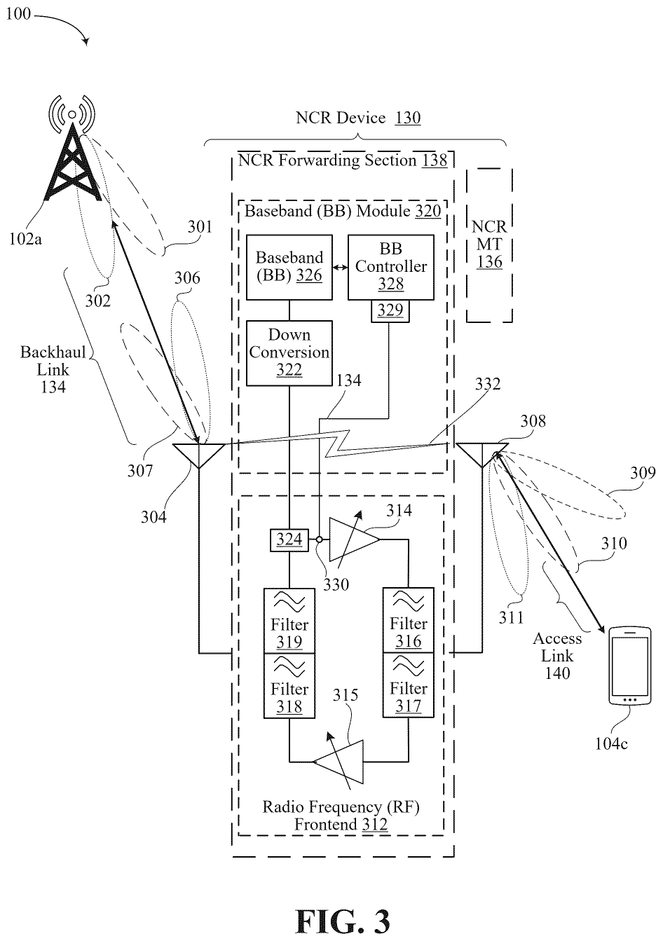

FIG. 3 is a diagram of the wireless communication system 100 for repeating wireless communication by the NCR forwarding section 138, illustrating NCR Rx/Tx beam pairs and self-interference. In an example, network device 102a communicates on Rx/Tx beams 301-302 on backhaul link 134. Network device 102a may use the same beams or other beams for control link 132 (FIG. 2). One or more backhaul antennas 304 of NCR device 130 are configured with Rx/Tx beams 306-307 to communicate via the backhaul link 134 with the network device 102a. One or more access antennas 308 of NCR device 130 are configured with Rx/Tx beams 309, 310, and 311 to concurrently communicate via the access link 140 with the UE 104a. The RF frontend 312 of the NCR forwarding section 138 includes adjustable amplifiers 314-315 and filters 316, 317, 318, and 319 connected between the one or more backhaul antennas 304 and the one or more access antennas 308. The RF frontend 312 amplifies and transmits DL RF signals received at the one or more backhaul antennas 304 and transmits at the one or more access antennas 308. Concurrently, the RF frontend 312 amplifies and transmits UL RF signals received at the one or more access antennas 308 and transmits at the one or more backhaul antennas 304. To detect information carried in the DL RF signals, a baseband (BB) module 320 includes a down conversion component 322 that monitors a pickup point 324 in the RF frontend 312. A down converted baseband signal is processed by a baseband modem 326 under control of a baseband controller 328. The baseband controller 328 is connected by an RF288 interface 329 to receive self-interference measurements from a measurement point 330 in the RF frontend 312. Self-interference 332 is between the one or more backhaul antennas 304 and the one or more access antennas 308. NCR MT 136 would similarly use the one or more backhaul antennas 304 or other dedicated control link antennas.

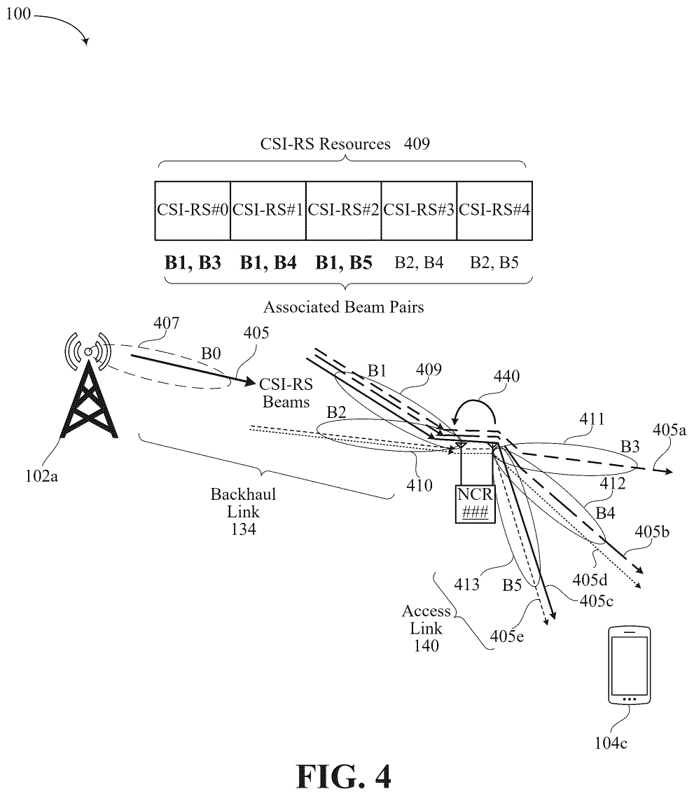

According to embodiment 1, FIG. 4 is a block diagram of the wireless communication system 100 with the NCR device 130 configured by the network device 102a to receive and forward multiple CSI-RS beams 405 on the forward link to a UE 104a via beam B0 407 for DL beam selection and refinement. The NCR device 130 is configured with beams B1 409 and B2 410 on the backhaul link 134 and beams B3 411, B4 412, and B5 413 on the access link 140. The configuration includes an indication for associating each of the CSI-RS resources 409 with a beam pair of an Rx beam and a Tx beam at the NCR device 130. Each CSI-RS beam 405a, 405b, 405c, 405d, and 405e of the multiple CSI-RS beams 405 may be transmitted over a distinct set of time slots. The NCR device 130 switches the Rx beam of the backhaul link 134 and the Tx beam of the access link 140 corresponding to the associated beam pair for each CSI-RS 405a-405e towards the UE 104a. The UE 104a is configured by the network device 102a to report the corresponding CSI measurement report for each CSI-RS, i.e., corresponding to each beam pair activated by the NCR device 130. Upon receiving the CSI report from the UE 104a comprising indicator(s) for each beam pair, the network device 102a sends a second configuration to the NCR device 130, wherein the configuration includes a list of CSI-RS resources corresponding to a set of beam pairs reported by the UE, wherein the list may contain the beam pairs reported by the UE 104a with low-quality CSI measurement, indicated not in bold font.

The NCR device 130 is configured to measure the self-interference power caused by an interference signal 440 (access to backhaul) in the RF circuit of the forward link for each of the indicated list of the CSI-RS resources using the corresponding beam pair association indicated in the first configuration. The network device 102a identifies the beam pairs associated with CSI-RS #4,5 as potential beam pairs for which the self-interference at the NCR device 130 is high after the NCR device 130 measures the identified beam pairs (B #2-B #4 and B #2-B #5), the one or more beam pairs with high self-interference are indicated to the network. In one implementation, the second configuration contains an activation command to trigger the NCR device 130 to measure and report the self-interference for all the CSI-RS resources indicated in the first configuration. In another implementation, the NCR device 130 is configured to measure only the CSI-RS resources with e.g., reported CRI-rsrp lower than a pre-defined threshold. The second configuration further includes indication to report the self-interference power for each of the configured CSI-RS resources. In one implementation, the NCR device 130 is configured to report the measurement of all the CSI-RS resources indicated in the second configuration. In another implementation, the NCR device 130 is configured to report only the measurement corresponding to the beam pairs that cause high self-interference in the RF circuit which crosses a pre-defined threshold. Wherein the report is sent in a feedback channel to the network device 102a, in one example using UCI over PUCCH specific to the NCR-MT, in another example using UCI over PUSCH of the NCR-MT.

The network device 102a sends to the NCR device 130 a third configuration, wherein the configuration includes a new association of CSI-RS resources with the beam pairs at the NCR device 130 such that the beam pairs with high self-interference are not considered by the NCR device 130. In one implementation, the configuration is in a form of a beam restriction bitmap, wherein a sequence of binary bits with each bit in the sequence of binary bits corresponds to a distinct beam pair, and a value one of the binary bit indicates that the corresponding beam pair cannot be used by the NCR-MT, and a value zero of the binary bit indicates that the corresponding beam pair can be used by the NCR-MT. Alternatively, a value one of the binary bit indicates that the corresponding beam pair can be used by the NCR-MT, and a value zero of the binary bit indicates that the corresponding beam pair cannot be used by the NCR-MT.

In alternative embodiment, the NCR device 130 is configured by the network with a flag to be signaled by the NCR device 130 in the feedback channel, where the flag indicates the occurrence of the self-interference of one or more beam pairs. Upon receiving the flag, the network device 102a sends a second configuration to the NCR device 130, wherein the configuration indicates UL resources for reporting a list of the beam pairs that have been measured with high self-interference. In one implementation, the NCR reports a beam pair used for the DL or UL communication indicating a high self-interference, where the self-interference is measured based on the forwarded DL or UL signal (e.g., PUSCH, PDSCH) from the NCR. The NCR device 130 then reports on the feedback channel using NCR-MT PUCCH/PUSCH the CSI-RS resource IDs corresponding to each of the self-interfered beam pair.

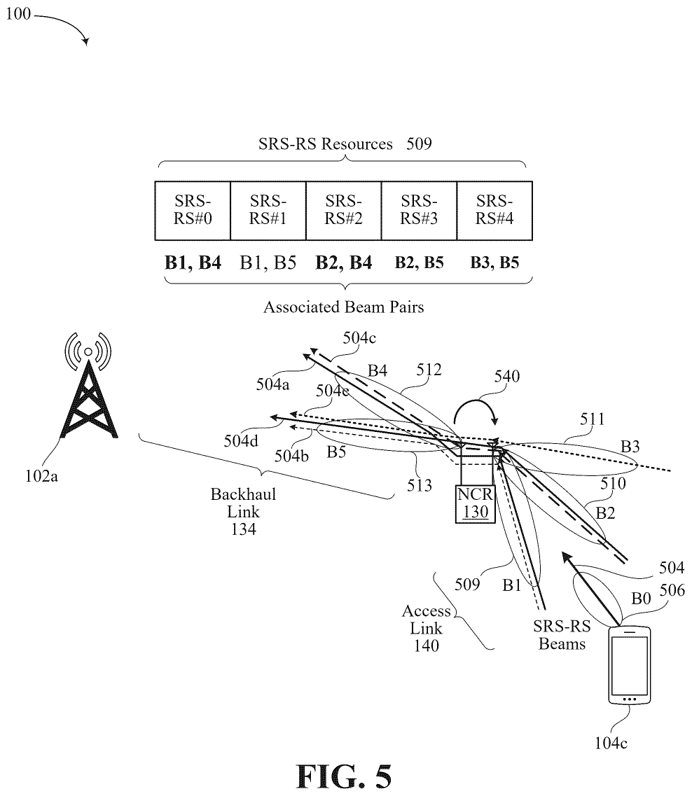

According to embodiment 2, FIG. 5 is a diagram of the wireless communication system 100 with the NCR device 130 configured by the network device 102a to receive and forward multiple SRS resources/beams from the UE 104a to the network device 102a on the forward link for UL beam selection and refinement. The UE 104a transmits SRS-RS beams 504 via beam B0 506. The NCR device 130 is configured with beams B1 509, B2 510, and B3 511 on the access link 140 and beams B4 512 and B5 513 on the backhaul link 134. The configuration includes indication for associating each of the SRS resources/beams 504a, 504b, 504c, 504d, and 504e with a beam pair of an Rx beam and a Tx beam at the NCR device 130. The NCR device 130 switches the Rx beam of the access link 140 and the Tx beam of the backhaul link 134 corresponding to the associated beam pair for each SRS resource transmitted by the UE. Upon receiving and measuring the multiple SRS beams forwarded using different beam pairs by the NCR device 130, the network device 102a sends a second configuration to the NCR device 130, wherein the configuration includes a list of SRS resource IDs corresponding to a set of beam pairs measured by the network device 102a, wherein the list may contain indication of the beam pairs measured with low-quality as illustrated in FIG. 3.

The NCR device 130 is configured to measure the self-interference power from interference signal 540 (backhaul to access) in the RF circuit of the forward link for each of the indicated list of the SRS beam IDs/resources 509 while activating the corresponding beam pairs indicated in the first configuration. In one implementation, the second configuration contains an activation command to trigger the NCR device 130 to measure and report the self-interference for the beam pairs correspond to all SRS beam IDs. In another implementation, the NCR device 130 is configured to measure only the beam pairs corresponding with the measured low-quality beams, lower than a pre-defined threshold. The second configuration further includes indication to report the self-interference power for each of the configured SRS resources. In one implementation, the NCR device 130 is configured to report the measurement of all the SRS resources indicated in the second configuration. In another implementation, the NCR device 130 is configured to report only the measurement corresponding to the beam pairs that cause high self-interference in the RF circuit that crosses a pre-defined threshold. The report is sent in a feedback channel to the network device 102a, in one example using UCI over PUCCH specific for the NCR-MT, in another example using UCI over PUSCH of the NCR-MT.

The network device 102a sends to the NCR device 130 a third configuration, wherein the configuration includes new association of SRS resources with the beam pairs at the NCR device 130 such that the beam pairs with high self-interference is not considered by the NCR device 130. In one implementation, the configuration is in a form of a beam restriction bitmap, wherein a sequence of binary bits with each bit in the sequence of binary bits corresponds to a distinct beam pair, and a value one of the binary bit indicates that the corresponding beam pair cannot be used by the NCR-MT, and a value zero of the binary bit indicates that the corresponding beam pair can be used by the NCR-MT. Alternatively, a value one of the binary bit indicates that the corresponding beam pair can be used by the NCR-MT, and a value zero of the binary bit indicates that the corresponding beam pair cannot be used by the NCR-MT.

In alternative embodiment, the NCR device 130 is configured by the network with a flag to be signaled in the feedback channel, where the flag indicates the occurrence of the self-interference of one or more beam pairs of the forwarded UL. Upon receiving the flag, the network device 102a sends a second configuration to the NCR device 130, wherein the configuration indicates UL resources to report indication of a list of the beam pairs with high self-interference. The NCR device 130 then reports on the feedback channel using NCR-MT PUCCH/PUSCH the SRS source IDs corresponding to each of the self-interfered beam pair.

In some alternate embodiments, the explicit Tx-Rx beam pairs at the NCR device 130 node that cause self-interference are not indicated to the gNB. As such, the number of the CSI-RS resources at the gNB is based on the indicated/reported number of the self-interference free beam pairs at the NCR, which may serve the intended DL/UL communication, according to the NCR indication.

In some embodiments, the NCR configuration includes one or multiple time durations, for which the detected Tx/Rx beam pairs with self-interference shall be excluded from further measurement and/or reporting by the NCR.

In some embodiments, the NRC report includes the number of beam pairs at the NCR that satisfy some permissibility conditions, where the said permissibility condition may include one or multiple of
(i) Beam pair for which the self-interference has not been detected, according to an indicated interference power threshold and/or an indicated time duration;
(ii) Beam pair for which an angular relation holds among the Tx beam angle, Rx beam angle, angle of gNB-NCR LOS path, angle of the NCR-UE LOS path, or a subset thereof. An example of the said beam pair angular relation includes the number of beam pairs with a Tx beam within 30-degree margin of the UE LOS direction from the NCR, an Rx beam within 30 degree margin of the gNB LOS direction towards NCR, and a minimum of 60 degree separation between the Tx and Rx beam directions at the NCR;
(iii)Beam pairs for which the reception beam from the backhaul link (or transmission beam towards the gNBin UL) is within any of an indicated set of the prior CSI-RS/SRS measurements; and
(iv) Beam pairs for which the transmission beam towards the UE (or reception beam from the UE in UL) is within any of an indicated set of the prior CSI-RS/SRS measurements.

In some embodiments, the gNB indicates the NCR-MT with a dynamic, semi-static, or a periodic resource to report the number of the permissible beam pairs, according to the said permissibility condition.

In some embodiments, the number of the supported beam pairs at the NCR, with or without angular information with respect to a global or local coordinate system known by the gNB, as well as the self-interference measurement capability is indicated as a capability information element to the gNB by the NCR.

According to embodiment 3, a network-controlled repeater (NCR-MT) 130 is configured by the network to generate and transmit UL signal using multiple beams in the backhaul link. Wherein the beams are within the active BWP of the component carrier used for the forward link. In one implementation, the signal is a PUCCH signal transmitted with different Tx beams at the backhaul link. In the other implementation, the signal is an SRS sequence sent in multiple Tx beams towards the network device 102a. The network device 102a configures the repeater to measure the received power at different Rx beam on the access link. Note that the UE during the measurement is configured with no UL transmission so that the measured received power represents the leakage between the Tx beam(s) at the backhaul link to the Rx beam(s) at the access link. The network device 102a configures the repeater to report the beam pairs with high self-interference. In another example, the network-controlled repeater (NCR) is configured by the network to generate and transmit a signal using multiple beams in the access link. Wherein the signal beams are within the active BWP of the component carrier used for the forward link. The repeater measures the received power at the backhaul link during the absence of DL signal from the network device 102a (the network device 102a does not transmit DL signal towards the repeater in this measurement period). The repeater reports to the network the beam pairs that cause high self-interference. In one implementation, the resource(s) at which the NCR transmits the signal are associated with a zero-power CSI-RS resource ID indicated as part of the control signaling transmitted by the network node to the NCR. In one example, the zero-power CSI-RS resource ID is indicated as part of a CSI reporting setting for a set of at least one UE to measure interference power from the NCR.

In some embodiments, the configuration of the NCR for beam pair measurement includes indication of one or multiple maximum transmission power values according to which the NCR beam transmission shall be implemented. In some embodiments, the said indication of one or multiple maximum transmission power values is accompanied with indication of one or multiple transmission direction information such that the NCR beam pair measurements shall comply with the indicated maximum transmission power at the corresponding transmission direction.

In some embodiments, the indicated self-interference measurement threshold to the NCR is a normalized threshold to the transmit power used for the beam measurements. In some embodiments, the gNB indicates a period of NCR-based transmission for beam pair measurements to one or multiple UL/DL UEs, such that the transmission/reception of the data/control channels at the said UEs for the duration of the indicated NCR-based transmission for beam pair measurements is Muted for the corresponding resources, with a corresponding rate matching at the UL/DL UE around the muted resources Are performed with a modified MCS with a corresponding rate matching at the UL/DL UE around the resources with a modified MCS, according to a received indication from the gNB. Or a combination thereof.

According to aspects of the present disclosure, in one or more embodiments, a new signaling is provided for determining the best beam pair at the repeater for forwarding the CSI-RS to the UE. Configuration for associating CSI-RS resource with a beam pair is provided. Configuration for applying measurement of self-interference and reporting the affected beam pairs is provided. Similarly, a new signaling for determining the best beam pair at the repeater for forwarding the SRS from the UE is provided. This includes a configuration for associating SRS resource with a beam pair and a configuration for applying measurement of self-interference and reporting the affected beam pairs.

According to one or more embodiments of the present disclosure, a method at network-controlled repeater (NCR) device is provided. The method includes receiving a first configuration from the network for the association between the RS resources and Rx/Tx beam pairs at the NCR. The method includes receiving a second configuration from the network for measuring and reporting the self-interference of list of RS resources. The method includes sending measurement report including a list of beam pairs, that cause high self-interference, to the network device 102a. The method includes receiving a third configuration from the network including a restricted list of beam pairs.

In one or more embodiments, the associated RS resources are CSI-RS resources to be amplified and forwarded to the UE, and a repeater Rx/Tx beam pair corresponds to an Rx beam for the backhaul link and a Tx beam for the access link. In one or more embodiments, the associated RS resources are SRS resources/beams to be amplified and forwarded to the network device 102a, and a repeater Rx/Tx beam pair corresponds to an Rx beam for the access link and a Tx beam for the backhaul link. In one or more embodiments, the network device 102a identifies a list of DL beam pairs based on the reported CSI from the UE for each CSI-RS resource. In one or more particular embodiments, the identified beam pairs include DL beam pairs reported from the UE with low quality CSI measurement based on a pre-defined threshold.

In one or more embodiments, the network device 102a or network device identifies a list of UL beam pairs based on the measured SRS resources transmitted by the UE. In one or more particular embodiments, the identified beam pairs include UL beam pairs measured by the network device 102a with low quality SINR based on a pre-defined threshold.

In one or more embodiments, the second configuration from the network device 102a or network device to the NCR device includes a list of beam pairs corresponding to the associated CSI-RS resource IDs for the DL and the SRS resource IDs for the UL and trigger the repeater to measure and report the self-interference power for the CSI-RS/SRS resources corresponding to each of the indicated beam pairs. In one or more particular embodiments, the network device configures the NCR device to report the measurement of all the indicated beam pairs in the second configuration. Alternatively, the network device configures the NCR device to report only the beam pairs with self-interference that cross a pre-defined threshold.

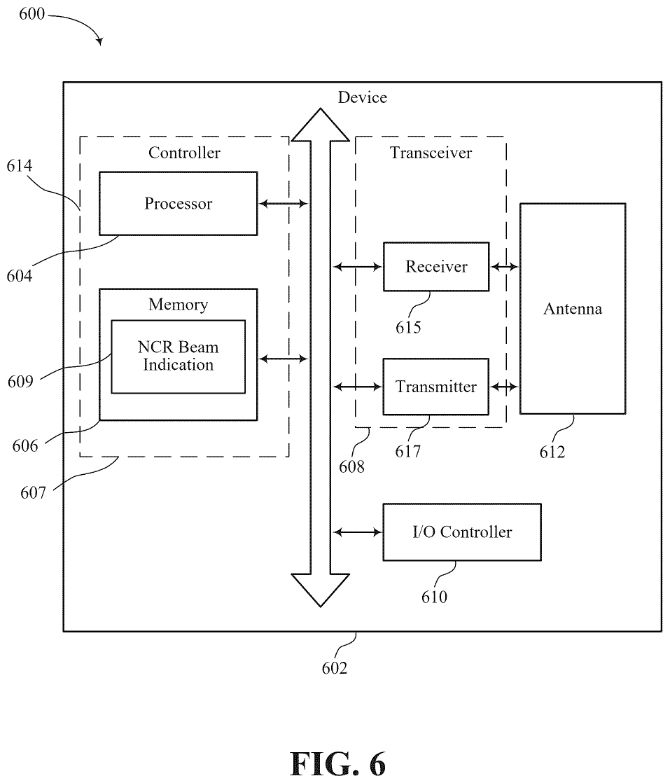

FIG. 6 illustrates an example of a block diagram 600 of a device 602 that supports beam indication for an NCR device, in accordance with aspects of the present disclosure. The device 602 may be an example of a network entity or network device 102 or a UE 104 (FIG. 1) as described herein. The device 602 may support wireless communication with one or more network entities or network devices 102, UEs 104, or any combination thereof. The device 602 may include components for bi-directional communications including components for transmitting and receiving communications, such as a processor 604, a memory 606, a transceiver 608, and an I/O controller 610. These components may be in electronic communication or otherwise coupled (e.g., operatively, communicatively, functionally, electronically, electrically) via one or more interfaces (e.g., buses).

The processor 604, the memory 606, the transceiver 608, or various combinations thereof or various components thereof may be examples of means for performing various aspects of the present disclosure as described herein. For example, the processor 604, the memory 606, the transceiver 608, or various combinations or components thereof may support a method for performing one or more of the operations described herein.

In some implementations, the processor 604, the memory 606, the transceiver 608, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 604 and the memory 606 coupled with the processor 604 may be components within a controller 607 configured to perform one or more of the functions as a controller 607, as described herein (e.g., executing, by the processor 604, instructions stored in the memory 606). In an example, the processor 604 of a device controller 614 executes an NCR beam measurement application 609 to function as an NCR-MT in determining a beam measurement for configuring a transceiver 608 of the device 602 to perform NCR forwarding.

The processor 604 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 604 may be configured to operate a memory array using a memory controller. In some other implementations, a memory controller may be integrated into the processor 604. The processor 604 may be configured to execute computer-readable instructions stored in a memory (e.g., the memory 606) to cause the device 602 to perform various functions of the present disclosure.

The memory 606 may include random access memory (RAM) and read-only memory (ROM). The memory 606 may store computer-readable, computer-executable code including instructions that, when executed by the processor 604 cause the device 602 to perform various functions described herein. The code may be stored in a non-transitory computer-readable medium such as system memory or another type of memory. In some implementations, the code may not be directly executable by the processor 604 but may cause a computer (e.g., when compiled and executed) to perform functions described herein. In some implementations, the memory 606 may include, among other things, a basic I/O system (BIOS) which may control basic hardware or software operation such as the interaction with peripheral components or devices.

The I/O controller 610 may manage input and output signals for the device 602. The I/O controller 610 may also manage peripherals not integrated into the device M02. In some implementations, the I/O controller 610 may represent a physical connection or port to an external peripheral. In some implementations, the I/O controller 610 may utilize an operating system such as iOS®, ANDROID®, MS-DOS®, MS-WINDOWS®, OS/2®, UNIX®, LINUX®, or another known operating system. In some implementations, the I/O controller 610 may be implemented as part of a processor, such as the processor 604. In some implementations, a user may interact with the device 602 via the I/O controller 610 or via hardware components controlled by the I/O controller 610.

In some implementations, the device 602 may include a single antenna 612. However, in some other implementations, the device 602 may have more than one antenna 612 (i.e., multiple antennas), including multiple antenna panels or antenna arrays, which may be capable of concurrently transmitting or receiving multiple wireless transmissions. The transceiver 608 may communicate bi-directionally using one or more receivers 615 and one or more transmitters 617, via the one or more antennas 612, wired, or wireless links as described herein. For example, the transceiver 608 may represent a wireless transceiver and may communicate bi-directionally with another wireless transceiver. The transceiver 608 may also include a modem to modulate the packets, to provide the modulated packets to one or more antennas 612 for transmission, and to demodulate packets received from the one or more antennas 612.

According to aspects of the present disclosure, the device 602 may be an NCR device 130 (FIGS. 1-6) for repeating wireless communication. The device 602 has the at least one transceiver 608 that includes at least one receiver 615 and at least one transmitter 617 that enable the device 602 to communicate with a network entity or network device 102a and to a user device such as UE 104a (FIG. 1). In particular, the at least one transceiver 608 enables the device 602 to communicate: (i) with at least one network device 102a (FIG. 1) of a wireless communications system 100 (FIG. 1) via (a) a control link 132 (FIGS. 1-5) or (b) a backhaul link 134 (FIGS. 1-5); and (ii) with a user device (UE 104a (FIG. 1)) via an access link 140 (FIGS. 1-5). A controller 607 of the device 602 is communicatively coupled to the at least one transceiver 608. The controller 607 receives, via the at least one transceiver 608 on the control link from the at least one network device, a first configuration that associates reference signal (RS) resources and more than one receive/transmit (Rx/Tx) beam pairs configurable at the apparatus for repeating one of: (i) a downlink (DL) radio frequency (RF) signal from the at least one network device to the user device; and (ii) an uplink (UL) RF signal from the user device to the at least one network device. The controller 607 receives, via the control link from the at least one network device, a second configuration for measuring and reporting self-interference of a first list of the RS resources. The controller 607 configures the transceiver with Rx/Tx beam pairs identified in the first list of RS references. While transmitting, via the transceiver over one of the access link and the backhaul link, a first RF signal via a Tx beam of a first Rx/Tx beam pair identified in the first list, the controller 607 measures self-interference received by the at least one transceiver on an Rx beam of the first Rx/Tx beam pairs. The controller 607 generates and forwards, to the at least one network device, a self-interference measurement report comprising a second list of Rx/Tx beam pairs, the second list being a first subset of Rx/Tx beam pairs from the first list of Rx/Tx beam pairs that causes self-interference above a threshold value.

In one or more embodiments, the controller 607 receives, from the at least one network device, a third configuration comprising a restricted list of Rx/Tx beam pairs that indicates a second subset of the first list of Rx/Tx beam pairs that are restricted from being used by the apparatus.

In one or more embodiments, the apparatus is a network-controlled repeater (NCR) device. The at least one transceiver 608 is configurable to concurrently repeat at least one of: (i) a downlink (DL) radio frequency (RF) signal via at least one DL receive/transmit (Rx/Tx) beam pair of more than one DL Rx/Tx beam pairs; and (ii) an uplink (UL) RF signal via at least one UL Rx/Tx beam pair of more than UL Rx/Tx beam pair.

According to aspects of the present disclosure, the device 602 may be a network device 102a (FIGS. 1-6) for managing repeating of wireless communication by a repeater device. The device 602 has the at least one transceiver 608 that includes at least one receiver 615 and at least one transmitter 617 that enable the device 602 to communicate with a repeater device via a control link and a backhaul link, the repeater device communicating with a user device via an access link. A controller 607 is communicatively coupled to the at least one transceiver 608. The controller 607 transmits, via the at least one transceiver on the control link to the repeater device, a first configuration that associates reference signal (RS) resources and more than one receive/transmit (Rx/Tx) beam pairs configurable at the repeater device for repeating one of: (i) a downlink (DL) radio frequency (RF) signal from the apparatus to the user device; and (ii) an uplink (UL) RF signal from the user device to the apparatus. The controller 607 transmits, via the control link to the repeater device, a second configuration comprising a first list of RS resources associated with pairs of Rx/Tx beam pairs at repeater device to one of: (i) measure and report self-interference at the repeater device for a Tx beam on the access link interfering with an Rx beam on the backhaul link; (ii) measure and report self-interference at the repeater device for a Tx beam on the backhaul link interfering with an Rx beam on the access link; (iii) repeat a reference signal from the apparatus for measuring and reporting by the user device; and (iv) repeat a reference signal from the user device for measuring by the apparatus.

In one or more embodiments, the controller 607 obtains measurements from a corresponding one of the user device and the apparatus. Based on the measurements, the controller 607 identifies pairs of the Rx/Tx beam pairs to include in a restricted list for the repeater device to not use when mitigating degradation of communication between the apparatus and the user device, routed via the repeater device. Degradation of communication results from one or more of misalignment of Rx/Tx beam pairs with a target device and from self-interference at the repeater device. The controller 607 transmits, via the control link to the repeater device, a third configuration comprising the restricted list of Rx/Tx beam pairs that indicates second of Rx/Tx beam pairs that are restricted from being used by the apparatus.

In one or more embodiments, the controller 607 transmits, via the control link to the network device, the second configuration comprising the first list of RS resources that configure the repeater device with pairs of Rx/Tx beam pairs to measure and report self-interference at the repeater device for a Tx beam on the access link interfering with an Rx beam on the backhaul link.

In one or more embodiments, the controller 607 transmits, via the control link to the network device, the second configuration comprising the first list of RS resources that configure the repeater device with pairs of Rx/Tx beam pairs to measure and report self-interference at the repeater device for a Tx beam on the backhaul link interfering with an Rx beam on the access link.

In one or more embodiments, the controller 607 transmits, via the control link to the network device, the second configuration comprising the first list of RS resources that configure the repeater device with pairs of Rx/Tx beam pairs to repeat a reference signal from the apparatus for measuring and reporting by the user device.

In one or more embodiments, the controller 607 transmits, via the control link to the network device, the second configuration comprising the first list of RS resources that configure the repeater device with pairs of Rx/Tx beam pairs to repeat a reference signal from the user device for measuring by the apparatus.

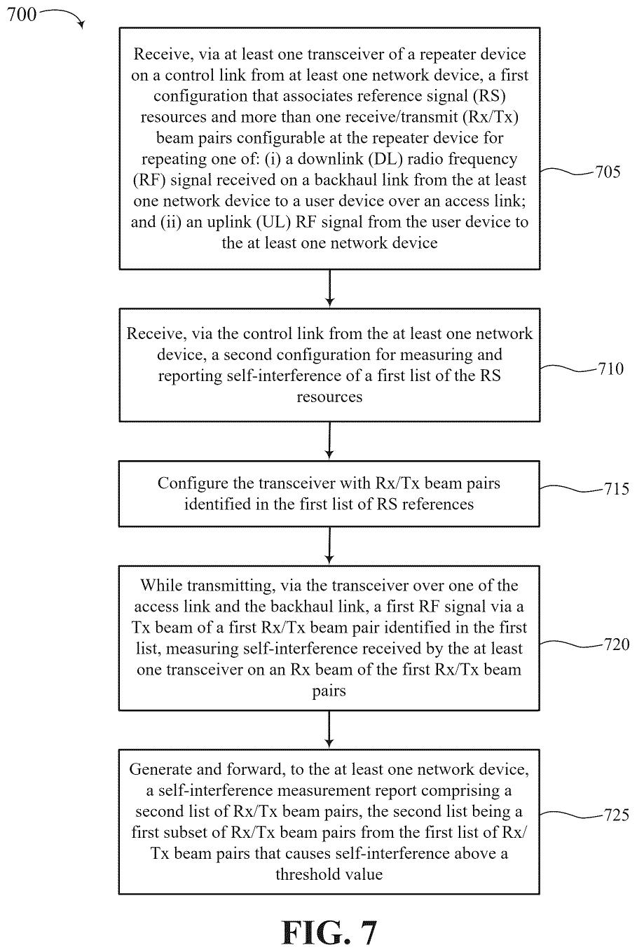

FIG. 7 illustrates a flowchart of a method 700 that enable an NCR device to select an appropriate beam pair for effective forwarding of wireless communication between a network device and a UE, in accordance with aspects of the present disclosure. The operations of the method 700 may be implemented by a device or its components as described herein. For example, the operations of the method 700 may be performed by a repeater device such as NCR device 130 (FIGS. 1-5) or device 602 (FIG. 6). In some implementations, the user device may execute a set of instructions to control the function elements of the network device to perform the described functions. Additionally, or alternatively, the user device may perform aspects of the described functions using special-purpose hardware.

At 705, the method 700 may include receiving, via at least one transceiver of a repeater device on a control link from at least one network device, a first configuration that associates reference signal (RS) resources and more than one receive/transmit (Rx/Tx) beam pairs configurable at the repeater device for repeating one of: (i) a downlink (DL) radio frequency (RF) signal received on a backhaul link from the at least one network device to a user device over an access link; and (ii) an uplink (UL) RF signal from the user device to the at least one network device. The operations of 705 may be performed in accordance with examples as described herein. In some implementations, aspects of the operations of 705 may be performed by a device as described with reference to FIGS. 1-6.

At 710, the method 700 may include receiving, via the control link from the at least one network device, a second configuration for measuring and reporting self-interference of a first list of the RS resources. The operations of 710 may be performed in accordance with examples as described herein. In some implementations, aspects of the operations of 710 may be performed by a device as described with reference to FIGS. 1-6.

At 715, the method 700 may include configuring the transceiver with Rx/Tx beam pairs identified in the first list of RS references. The operations of 715 may be performed in accordance with examples as described herein. In some implementations, aspects of the operations of 715 may be performed by a device as described with reference to FIGS. 1-6.

At 720, the method 700 may include while transmitting, via the transceiver over one of the access link and the backhaul link, a first RF signal via a Tx beam of a first Rx/Tx beam pair identified in the first list, measuring self-interference received by the at least one transceiver on an Rx beam of the first Rx/Tx beam pairs. The operations of 720 may be performed in accordance with examples as described herein. In some implementations, aspects of the operations of 720 may be performed by a device as described with reference to FIGS. 1-6.

At 725, the method 700 may include generating and forwarding, to the at least one network device, a self-interference measurement report comprising a second list of Rx/Tx beam pairs, the second list being a first subset of Rx/Tx beam pairs from the first list of Rx/Tx beam pairs that causes self-interference above a threshold value. The operations of 725 may be performed in accordance with examples as described herein. In some implementations, aspects of the operations of 725 may be performed by a device as described with reference to FIGS. 1-6.

In one or more embodiments, the method 700 may include receiving from the at least one network device, a third configuration comprising a restricted list of Rx/Tx beam pairs that indicates a second subset of the first list of Rx/Tx beam pairs that are restricted from being used by the repeater device.

In one or more embodiments, the repeater device is a network-controlled repeater (NCR) device. The at least one transceiver is configurable to concurrently repeat at least one of: (i) a downlink (DL) radio frequency (RF) signal via at least one DL receive/transmit (Rx/Tx) beam pair of more than one DL Rx/Tx beam pairs; and (ii) an uplink (UL) RF signal via at least one UL Rx/Tx beam pair of more than UL Rx/Tx beam pair.

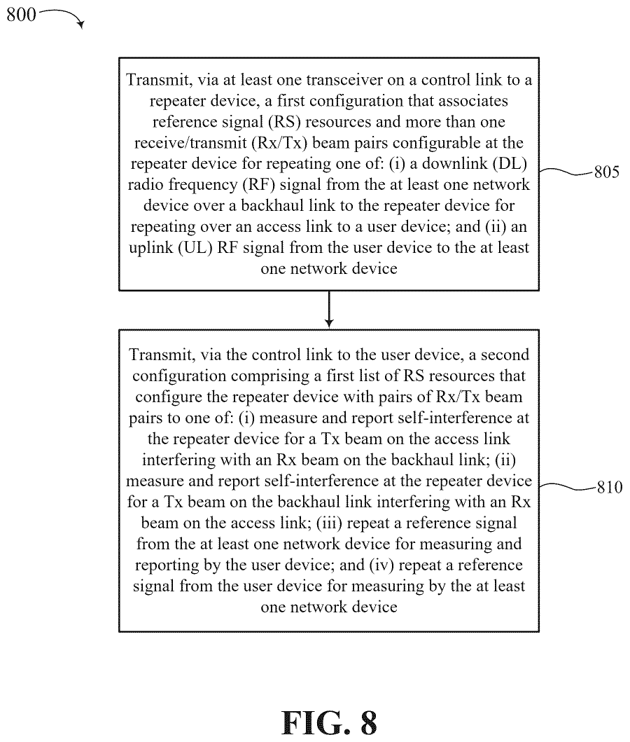

FIG. 8 illustrates a flowchart of a method 800 that enable a network device to control an NCR device to select an appropriate beam pair for effective forwarding of wireless communication between a network device and a UE, in accordance with aspects of the present disclosure. The operations of the method 800 may be implemented by a device or its components as described herein. For example, the operations of the method 800 may be performed by a network device 102 (FIGS. 1-5) or device 602 (FIG. 6). In some implementations, the user device may execute a set of instructions to control the function elements of the network device to perform the described functions. Additionally, or alternatively, the user device may perform aspects of the described functions using special-purpose hardware.

At 805, the method 800 may include transmitting, via at least one transceiver on a control link to a repeater device, a first configuration that associates reference signal (RS) resources and more than one receive/transmit (Rx/Tx) beam pairs configurable at the repeater device for repeating one of: (i) a downlink (DL) radio frequency (RF) signal from the at least one network device over a backhaul link to the repeater device for repeating over an access link to a user device; and (ii) an uplink (UL) RF signal from the user device to the at least one network device. The operations of 805 may be performed in accordance with examples as described herein. In some implementations, aspects of the operations of 805 may be performed by a device as described with reference to FIGS. 1-6.

At 810, the method 800 may include transmitting, via the control link to the user device, a second configuration comprising a first list of RS resources that configure the repeater device with pairs of Rx/Tx beam pairs to one of: (i) measure and report self-interference at the repeater device for a Tx beam on the access link interfering with an Rx beam on the backhaul link; (ii) measure and report self-interference at the repeater device for a Tx beam on the backhaul link interfering with an Rx beam on the access link; (iii) repeat a reference signal from the at least one network device for measuring and reporting by the user device; and (iv) repeat a reference signal from the user device for measuring by the at least one network device. The operations of 810 may be performed in accordance with examples as described herein. In some implementations, aspects of the operations of 810 may be performed by a device as described with reference to FIGS. 1-6.

In one or more embodiments, the method 800 may include obtaining measurements from a corresponding one or more of the user device, the repeater device, and the at least one network device. Based on the measurement, the method 800 may include identifying pairs of the Rx/Tx beam pairs to include in a restricted list for the repeater device to not use when mitigating degradation of communication between the at least one network device and the user device, routed via the repeater device, degradation of communication resulting from one or more of misalignment of Rx/Tx beam pairs with a target device and from self-interference at the repeater device. The method 800 may include transmitting, via the control link to the repeater device, a third configuration comprising the restricted list of Rx/Tx beam pairs that indicates second of Rx/Tx beam pairs that are restricted from being used by the repeater device.

In one or more embodiments, the method 800 may include transmitting, via the control link to the network device, the second configuration comprising the first list of RS resources that configure the repeater device with pairs of Rx/Tx beam pairs to measure self-interference at the repeater device for a Tx beam on the access link interfering with an Rx beam on the backhaul link.

In one or more embodiments, the method 800 may include transmitting, via the control link to the network device, the second configuration comprising the first list of RS resources that configure the repeater device with pairs of Rx/Tx beam pairs to measure and report self-interference at the repeater device for a Tx beam on the backhaul link interfering with an Rx beam on the access link.

In one or more embodiments, the method 800 may include transmitting, via the control link to the network device, the second configuration comprising the first list of RS resources that configure the repeater device with pairs of Rx/Tx beam pairs to repeat a reference signal from the at least one network device for measuring and reporting by the user device.

In one or more embodiments, the method 800 may include transmitting, via the control link to the network device, the second configuration comprising the first list of RS resources that configure the repeater device with pairs of Rx/Tx beam pairs to repeat a reference signal from the user device for measuring by the at least one network device.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a network device 102a, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A device for repeating wireless communication, the device comprising:
at least one access link memory;
a processor communicatively coupled to the at least one transceiver memory and which is configured to cause the device to:
receive, on a control link from at least one base station, a first configuration that associates reference signal (RS) resources and more than one receive/transmit (Rx/Tx) beam pairs configurable at the apparatus for repeating one of: (i) a downlink (DL) radio frequency (RF) signal from the at least one base station to a user equipment (UE); and (ii) an uplink (UL) RF signal from the UE to the at least one base station, the device communicatively connected to the at least one base station via the control link and via a backhaul link and communicatively connected to the UE via an access link;
receive, via the control link from the at least one base station, a second configuration for measuring and reporting self-interference of a first list of the RS resources;
configure a transceiver of the device with Rx/Tx beam pairs identified in the first list of RS resources;
while transmitting, over one of the access link and the backhaul link, a first RF signal via a Tx beam of a first Rx/Tx beam pair identified in the first list, measure self-interference received on an Rx beam of the first Rx/Tx beam pairs; and
generate and forward, to the at least one base station, a self-interference measurement report comprising a second list of Rx/Tx beam pairs, the second list being a first subset of Rx/Tx beam pairs from the first list of Rx/Tx beam pairs that causes self-interference above a threshold value.

2. The device of claim 1, wherein the processor causes the device to receive, from the at least one base station, a third configuration comprising a restricted list of Rx/Tx beam pairs that indicates a second subset of the first list of Rx/Tx beam pairs that are restricted from being used by the device.

3. The device of claim 1, wherein:
the device comprises a network-controlled repeater (NCR) device; and
the device is configurable to concurrently repeat at least one of: (i) a downlink (DL) radio frequency (RF) signal via at least one DL receive/transmit (Rx/Tx) beam pair of more than one DL Rx/Tx beam pairs; and (ii) an uplink (UL) RF signal via at least one UL Rx/Tx beam pair of more than UL Rx/Tx beam pair.

4. A controller for repeating wireless communication, the controller comprising:
at least one memory; and
a processor communicatively coupled to the at least one memory and which configures the controller to:
receive, via a connected transceiver over a backhaul link from at least one base station, a first configuration that associates reference signal (RS) resources and more than one receive/transmit (Rx/Tx) beam pairs configurable at the apparatus for repeating one of: (i) a downlink (DL) radio frequency (RF) signal from the at least one base station to a user equipment (UE); and (ii) an uplink (UL) RF signal from the UE to the at least one base station;
receive, via a control link from the at least one base station, a second configuration for measuring and reporting self-interference of a first list of the RS resources;
configure the apparatus with Rx/Tx beam pairs identified in the first list of RS resources;
while transmitting, over one of the access link and the backhaul link, a first RF signal via a Tx beam of a first Rx/Tx beam pair identified in the first list, measure self-interference received on an Rx beam of the first Rx/Tx beam pairs; and
generate and forward, to the at least one base station, a self-interference measurement report comprising a second list of Rx/Tx beam pairs, the second list being a first subset of Rx/Tx beam pairs from the first list of Rx/Tx beam pairs that causes self-interference above a threshold value.

5. The controller of claim 4, wherein the processor is further configured to cause the controller to receive, from the at least one base station, a third configuration comprising a restricted list of Rx/Tx beam pairs that indicates a second subset of the first list of Rx/Tx beam pairs that are restricted from being used by the apparatus.

6. The controller of claim 4, wherein:
the controller is communicatively connected within a network-controlled repeater (NCR) device; and
the NCR device is configurable to concurrently repeat at least one of: (i) a downlink (DL) radio frequency (RF) signal via at least one DL receive/transmit (Rx/Tx) beam pair of more than one DL Rx/Tx beam pairs; and (ii) an uplink (UL) RF signal via at least one UL Rx/Tx beam pair of more than UL Rx/Tx beam pair.

7. A method for repeating wireless communication by a repeater device, the method comprising:
receiving, on a control link from at least one base station, a first configuration that associates reference signal (RS) resources and more than one receive/transmit (Rx/Tx) beam pairs configurable at the repeater device for repeating one of: (i) a downlink (DL) radio frequency (RF) signal received on a backhaul link from the at least one base station to a user equipment (UE) over an access link; and (ii) an uplink (UL) RF signal from the UE to the at least one base station;
receiving, via the control link from the at least one base station, a second configuration for measuring and reporting self-interference of a first list of the RS resources;
configuring a transceiver of the repeater device with Rx/Tx beam pairs identified in the first list of RS resources;
while transmitting, over one of the access link and the backhaul link, a first RF signal via a Tx beam of a first Rx/Tx beam pair identified in the first list, measuring self-interference received on an Rx beam of the first Rx/Tx beam pairs; and
generating and forwarding, to the at least one base station, a self-interference measurement report comprising a second list of Rx/Tx beam pairs, the second list being a first subset of Rx/Tx beam pairs from the first list of Rx/Tx beam pairs that causes self-interference above a threshold value.

8. The method of claim 7, further comprising, receiving from the at least one base station, a third configuration comprising a restricted list of Rx/Tx beam pairs that indicates a second subset of the first list of Rx/Tx beam pairs that are restricted from being used by the repeater device.

9. The method of claim 7, wherein:
the repeater device comprises a network-controlled repeater (NCR) device; and
the repeater device is configurable to concurrently repeat at least one of: (i) a downlink (DL) radio frequency (RF) signal via at least one DL receive/transmit (Rx/Tx) beam pair of more than one DL Rx/Tx beam pairs; and (ii) an uplink (UL) RF signal via at least one UL Rx/Tx beam pair of more than UL Rx/Tx beam pair.

10. A base station for wireless communication, the base station comprising:
at least one backhaul memory;
at least one processor communicatively coupled to the at least one memory and which is configured to cause the base station to:
transmit, on a control link to a repeater device, a first configuration that associates reference signal (RS) resources and more than one receive/transmit (Rx/Tx) beam pairs configurable at the repeater device for repeating one of: (i) a downlink (DL) radio frequency (RF) signal from the base station to a user equipment (UE); and (ii) an uplink (UL) RF signal from the UE to the base station;
transmit, via the control link to the repeater device, a second configuration comprising a first list of RS resources associated with pairs of Rx/Tx beam pairs at the repeater device to one of: (i) measure and report self-interference at the repeater device for a Tx beam on the access link interfering with an Rx beam on the backhaul link; (ii) measure and report self-interference at the repeater device for a Tx beam on the backhaul link interfering with an Rx beam on the access link; (iii) repeat a reference signal from the apparatus for measuring and reporting by the UE; and (iv) repeat a reference signal from the user device for measuring by the base station.

11. The base station of claim 10, wherein the at least one processor is configured to cause the base station to:
obtain measurements from a corresponding one of the user device UE and the base station;
based on the measurements, identify pairs of the Rx/Tx beam pairs to include in a restricted list for the repeater device to not use when mitigating degradation of communication between the base station and the UE, routed via the repeater device, degradation of communication resulting from one or more of misalignment of Rx/Tx beam pairs with a target device and from self-interference at the repeater device; and
transmits, via the control link to the repeater device, a third configuration comprising the restricted list of Rx/Tx beam pairs that indicates second of Rx/Tx beam pairs that are restricted from being used by the repeater device.

12. The base station of claim 10, wherein the at least one processor is configured to cause the base station to transmits, via the control link to the repeater device, the second configuration comprising the first list of RS resources that configure the repeater device with pairs of Rx/Tx beam pairs to measure and report self-interference at the repeater device for a Tx beam on the access link interfering with an Rx beam on the backhaul link.

13. The base station of claim 10, wherein the at least one processor is configured to cause the base station to transmits, via the control link to the repeater device, the second configuration comprising the first list of RS resources that configure the repeater device with pairs of Rx/Tx beam pairs to measure and report self-interference at the repeater device for a Tx beam on the backhaul link interfering with an Rx beam on the access link.

14. The base station of claim 10, wherein the at least one processor is configured to cause the base station to transmits, via the control link to the repeater device, the second configuration comprising the first list of RS resources that configure the repeater device with pairs of Rx/Tx beam pairs to repeat a reference signal from the base station for measuring and reporting by the UE.

15. The base station of claim 10, wherein the at least one processor is configured to cause the base station to transmits, via the control link to the repeater device, the second configuration comprising the first list of RS resources that configure the repeater device with pairs of Rx/Tx beam pairs to repeat a reference signal from the UE for measuring by the base station.
